(19) United States
(12) Patent Application Publication
(10) Pub. No.: US 2025/0156522 A1
(43) Pub. Date: May 15, 2025

(54) CERTIFYING CAMERA IMAGES

(71) Applicant: Via Science, Inc., Somerville, MA (US)

(72) Inventors: Jesús Alejandro Cárdenes Cabré, Montreal (CA); Colin Gounden, Cambridge, MA (US); Madjid Aoudia, Montreal (CA); Jeremy Taylor, Montreal (CA)

(21) Appl. No.: 18/944,691

(22) Filed: Nov. 12, 2024

Related U.S. Application Data
(60) Provisional application No. 63/598,665, filed on Nov. 14, 2023.

(51) Int. Cl. G06F 21/44; G01M 11/02; H04L 9/00; H04L 9/32

(52) U.S. Cl. CPC G06F 21/44; G01M 11/0264; G01M 11/0278; H04L 9/3221; H04L 9/3257; H04L 9/50; G06F 2221/2129

(57) ABSTRACT

A system may certify that an image originated from a particular camera. A camera operator may register a camera by providing a public key and images captured using the camera and digitally signed with a corresponding private key. The system may train a machine learning model to identify image features resulting from physical characteristics of the camera. The system may subsequently receive a request to certify an image accompanied by the public key. The system may retrieve the model using the public key and determine a probability that the image originated from the camera. The system may compute a zero-knowledge proof that the image was certified so that the model itself need not be exposed. The system may defend against adversarial attacks that flood the system with manipulated duplicate images in an attempt to trick the model by rejecting images insufficiently different from other recently received images.

### CROSS-REFERENCE TO RELATED APPLICATION

This application claims the benefit of priority of U.S. Provisional Patent Application No. 63/598,665, filed Nov. 14, 2023, and entitled “SYSTEM TO CREATE DIGITAL CERTIFICATES TO VERIFY CAMERA IMAGES,” the content of which is incorporated herein by reference in its entirety.

### BRIEF DESCRIPTION OF DRAWINGS

For a more complete understanding of the present disclosure, reference is now made to the following description taken in conjunction with the accompanying drawings.

FIG. 1 is a conceptual diagram of an example environment of a system for verifying images, according to embodiments of the present disclosure.

FIG. 2A is a conceptual diagram illustrating example operations of registering a camera using the system, according to embodiments of the present disclosure.

FIG. 2B is a signal flow diagram illustrating example operations of registering the camera, according to embodiments of the present disclosure.

FIG. 3A is a conceptual diagram illustrating example operations of using the system to certify that an image originated from the operator's camera, according to embodiments of the present disclosure.

FIG. 3B is a signal flow diagram illustrating example operations of certifying the image, according to embodiments of the present disclosure.

FIG. 4A is a conceptual diagram illustrating example operations of using the system to verify that an image originated from a particular camera, according to embodiments of the present disclosure.

FIG. 4B is a signal flow diagram illustrating example operations of verifying the image, according to embodiments of the present disclosure.

FIG. 5 is a conceptual diagram illustrating example operations of a requestor obtaining a certificate from the distributed ledger, according to embodiments of the present disclosure.

FIG. 6 is a conceptual diagram illustrating example operations of registering a camera by training a model using the client device and recording the model hash and the client device's public key in the distributed ledger, according to embodiments of the present disclosure.

FIG. 7 is a flowchart illustrating an example method of the system, according to embodiments of the present disclosure.

FIG. 8 is a block diagram illustrating an example client device and system component communicating over a computer network, according to embodiments of the present disclosure.

### DETAILED DESCRIPTION

This disclosure describes a system and methods for verifying the origin of an image file (e.g., photograph) to establish that it was taken with a camera rather than being a “deep fake” or otherwise manipulated image. Deep fakes include image data, video data, audio data, etc., created to mislead a viewer/listener as to the source, subject, and/or content of the data. Modern deep fakes may be made using generative artificial intelligence models; however, the techniques described herein are not so limited and apply equally to deep fakes made using manual photo manipulation (e.g., airbrushing, splicing, etc.) and/or digital manipulation (e.g., via photo/audio editing software).

The techniques may be used to verify that image date (e.g., a digital photograph, video, scan, etc.) was taken by a particular camera that has previously registered with the system. The system may rely on a machine learning model trained on physical characteristics (e.g., defects) inside the camera itself. The model may be trained at the time of registration using images captured by the camera. Because many cameras are components of user devices (e.g., mobile phones, tablets, laptop computers, etc.), the model may be used in combination with an asymmetric key pair created in a secure enclave on the user device. Two additional techniques may be used to protect the model. First, the system may use a zero-knowledge proof (ZKP) to certify that an image matches the model while keeping the model private. Second, the system may include a mechanism to block an adversarial attack by preventing a generative model from learning to fool the camera verification model. The mechanism may add an extra layer of security in the event that an attacker is able to obtain the user device's cryptographic key.

In the registration process, the camera operator may capture one or more example images using the camera to be registered. The system may use the images to train a machine learning model to recognize features that indicate physical characteristics unique to the camera. The system may store the model for use in certifying future images uploaded by the camera operator and/or to verify that images uploaded by a third-party requestor correspond to the registered camera. In some implementations, the system may store a hash of the model in a distributed ledger (e.g., a blockchain). The hash stored in the distributed ledger may serve as an immutable reference that can be used to verify that the camera model has not been modified. In some implementations, the system may cause the user device associated with the camera (e.g., when the camera is part of a mobile phone or other personal electronic device) to generate a cryptographic key that may be used to digitally sign images. The user device may execute an application or “app,” to generate the cryptographic key in a secure enclave of the device. The app may be provided by the system and/or by a third-party system. The cryptographic key may be, for example, an asymmetric key pair with a private key stored securely on the user device and a public key provided to the system, which may associate the public key with the hash of the model. The device may implement post-quantum cryptography techniques to create cryptographic key pairs using a quantum-resistant public key algorithm.

Once the camera is registered, the camera operator may use the system to certify images captured by the camera. The camera operator may digitally sign an image using the private key and upload the signed image and public key to the system. The system may use the public key to extract the hash of the model and use the hash of the model to retrieve the model itself. In this manner, the system may determine that the same public key corresponds to the image and the model. The system may extract features from the image and process them using the model to determine a probability that the image originated from the corresponding camera. If the probability exceeds a threshold probability, the system may determine that the image is authentic, and calculate a ZKP of successful verification. The system may store a certificate of successful verification in the distributed ledger. The certificate may include a digital signature, the probability, a hash of the image, and/or the ZKP. The camera operator and/or other parties may use the certificate (memorialized in the distributed ledger) as proof of the authenticity of the image.

Third party requestors may use the system to verify the origin of an image using operations similar to those described above for certification of an image by a camera operator. The requestor may find an image on the Internet or receive the image via some other medium (e.g., email, text message, etc.). The image may include in its metadata a public key corresponding to a private key used to digitally sign the image. The requestor may send the image and its metadata to the system, which will use the public key to verify the image using the corresponding model. In some cases, the system may calculate a hash of the image, and use the hash to determine whether the image has been previously certified. If so, the system may return the previously created certificate. If the requestor has the certificate and uploads it with the image, the system may determine whether the image hash corresponds to the one associated with the certificate (e.g., as memorialized in the distributed ledger). In some cases, if the distributed ledger is accessible to other parties and the image has already been certified, the requestor may verify the certification themselves or by using a third-party service separate from the system. Otherwise, the system may perform the operations for certification described above and return a certification to the requestor.

In some implementations, the system may a mechanism to determine whether a received image is part of an adversarial attack. In an adversarial attack, an attacker may use a generative model or other software to generate many images by adding imperceptible noise in an attempt to figure out how to fool the camera verification model into believing an image came from the registered camera. The system may compare an image to images received within a window of time prior (e.g., half a minute to several minutes) and calculate a probability that the images differ by more than a certain distance. If the system determines the images are too similar (e.g., the probability is below a threshold), the system may half verification and return a failure notification.

The techniques described above may be used alone or in combination with each other and/or other techniques as described herein.

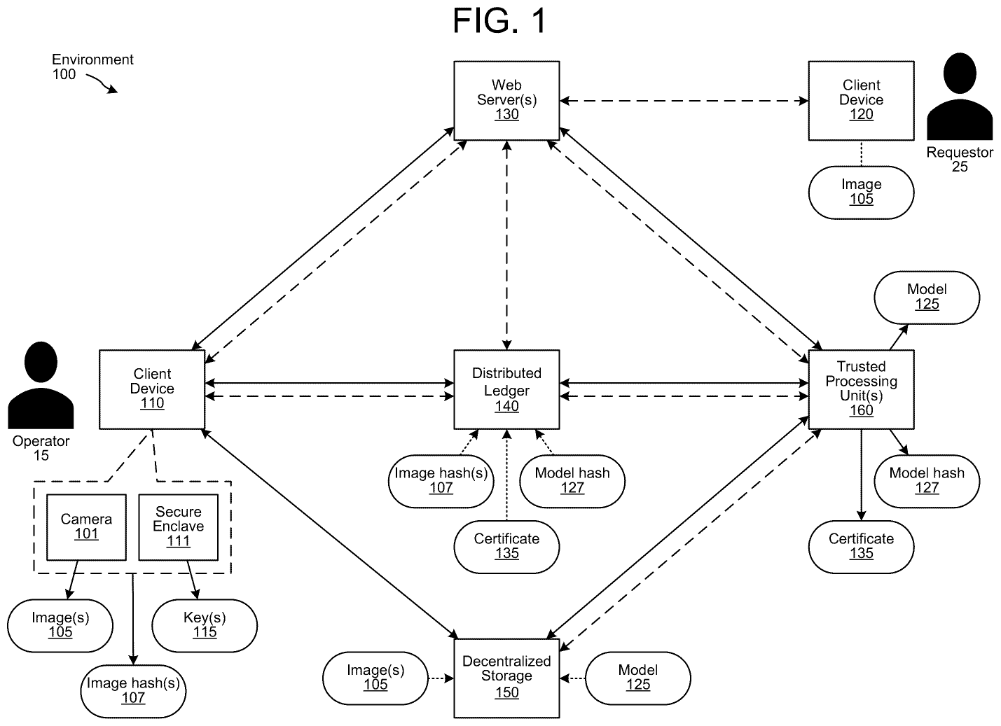

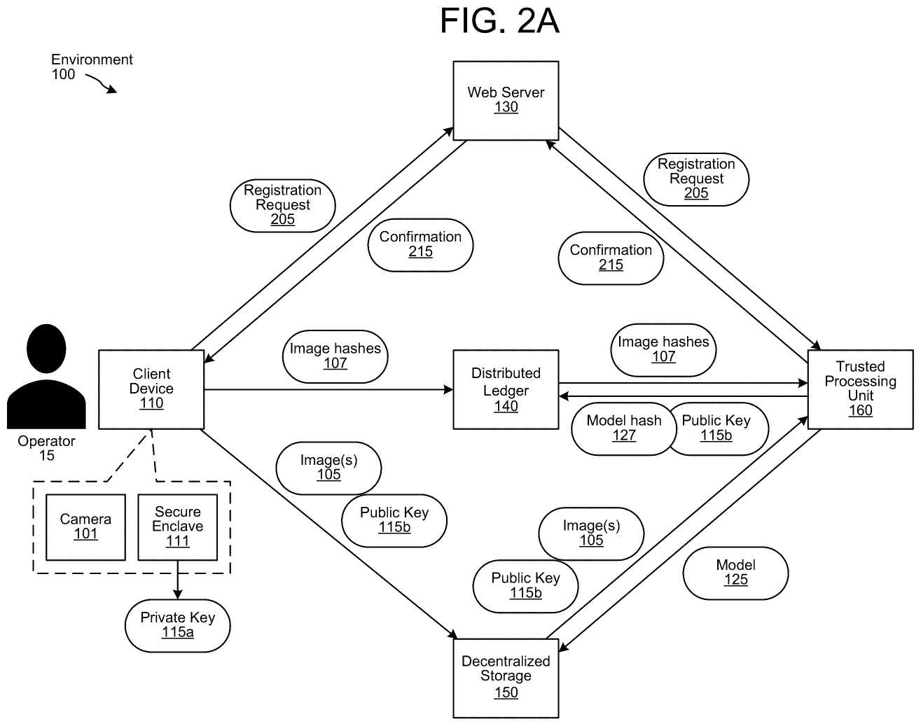

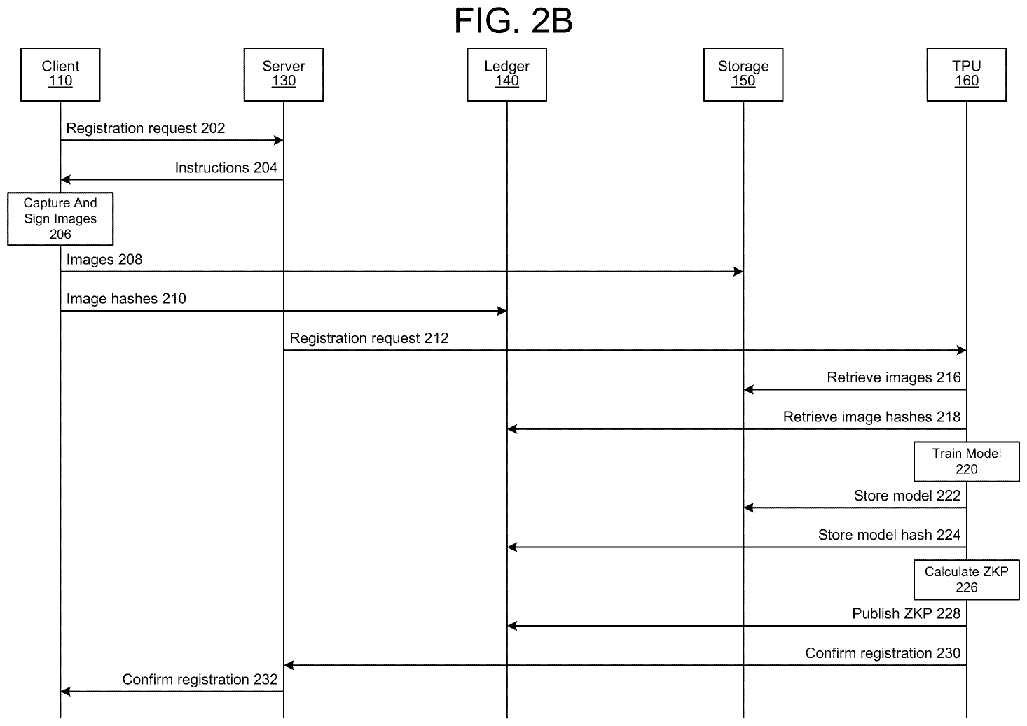

FIG. 1 is a conceptual diagram of an example environment 100 of a system for verifying images, according to embodiments of the present disclosure. The system may include one or more web servers 130 and/or one or more trusted processing units 160. An operator 15 of a client device 110 may register a camera 101 of the client device 110 with the system. The operator 15 may capture one or more image(s) 105 using the camera 101 and upload the images(s) 105 to the system via the web server(s) 130. The trusted processing unit(s) 160 may perform secure processing operations of the system including using the image(s) 105 to train a machine learning model 125 to determine that a particular image 105 image was captured by the camera 101. The client device 110 may also include a secure enclave 111 (e.g., hardware isolation and/or memory encryption) that may be used to create and/or store cryptographic keys 115. In some implementations, the client device 110 may execute a quantum-resistant algorithm in the secure enclave 111 to create a digital signature that is secure against cryptanalytic attacks by actors using quantum computers. This may add additionally security to use of the private key 115a against future decryption using the public key 115b and digitally signed images 105 persisted in the decentralized storage system 150 and/or elsewhere. Thus, the registration process may further include digitally signing the image(s) 105 with a private key and sending a corresponding public key to the web server(s) 130. Registration operations are indicated in FIG. 1 using solid arrows. The registration operations are described in further detail below with reference to FIGS. 2A and 2B.

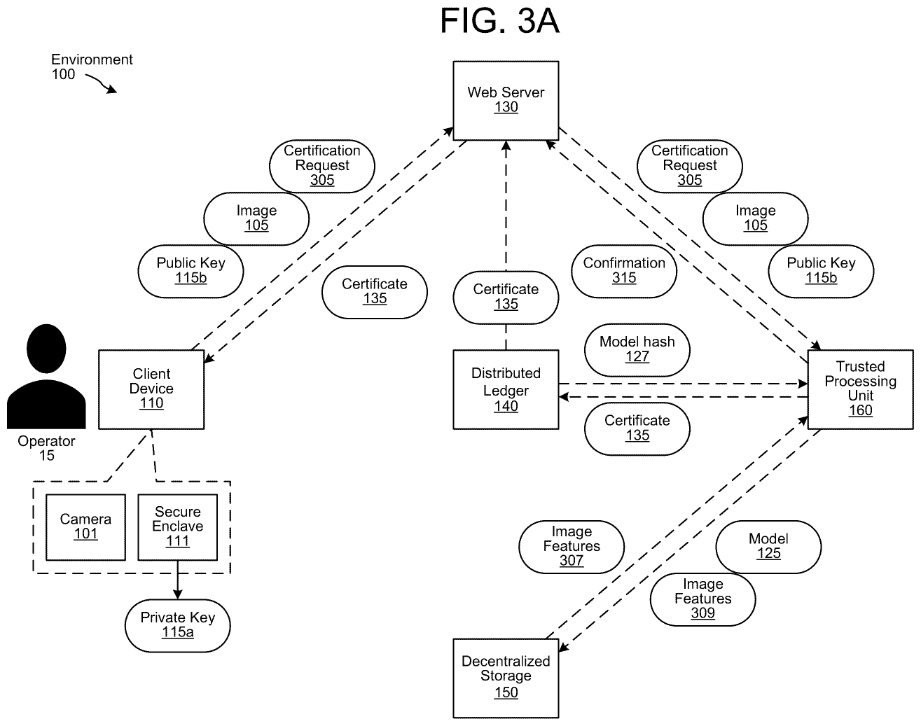

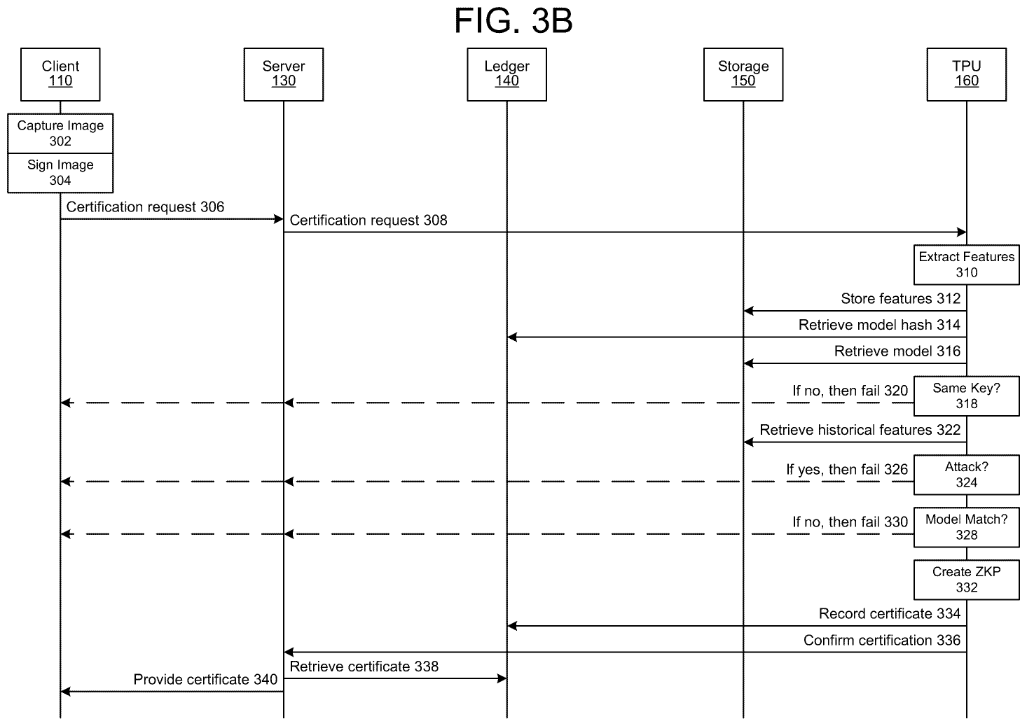

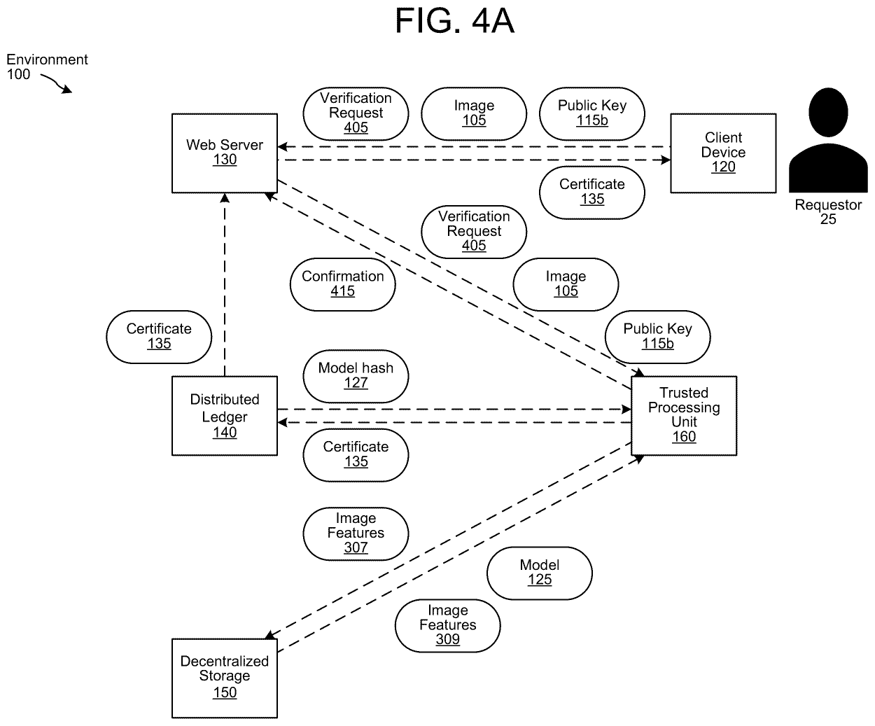

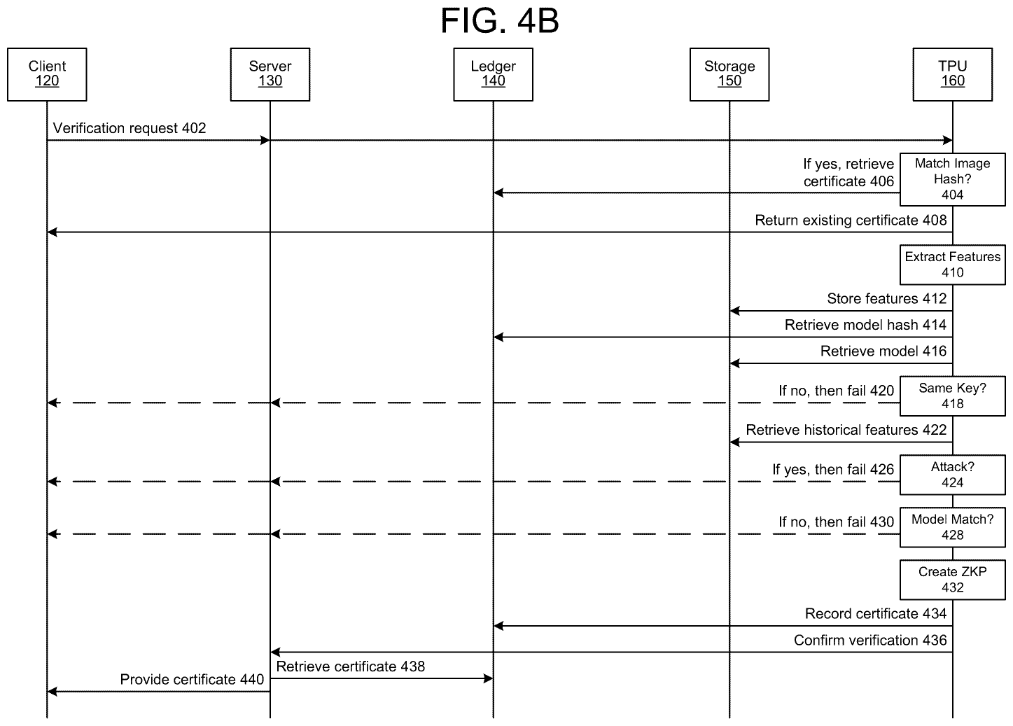

Following registration, the operator 15 may upload an image 105 to the web server(s) 130 for certification. The trusted processing unit(s) 160 may check the digital signature applied to the image 105, process the image 105 using the model 125, and/or check the image's similarity to other recently received images corresponding to the camera 101 (e.g., to determine that the image 105 is not part of an adversarial attack). If the trusted processing unit(s) 160 determine that the image 105 passes all checks (e.g., with sufficient probability), the trusted processing unit(s) 160 may create a certificate 135 indicating that the image 105 is authentic. Similarly, a requestor 25, operating a client device 120 other than the one associated with the camera 101, can upload an image 105 to the web server(s) 130 to verify that the image 105 originated from the client device 110/camera 101. If the system has already certified the image 105, the web server(s) 130 may return the corresponding certificate 135. If the system has not previously certified the image 105, the trusted processing unit(s) 160 may verify the image 105 using the model 125 and create a certificate 135. Certification and verification operations are indicated in FIG. 1. using dashed arrows. The certification operations are described in further detail below with reference to FIGS. 3A and 3B, and verification operations are described with reference to FIGS. 4A and 4B.

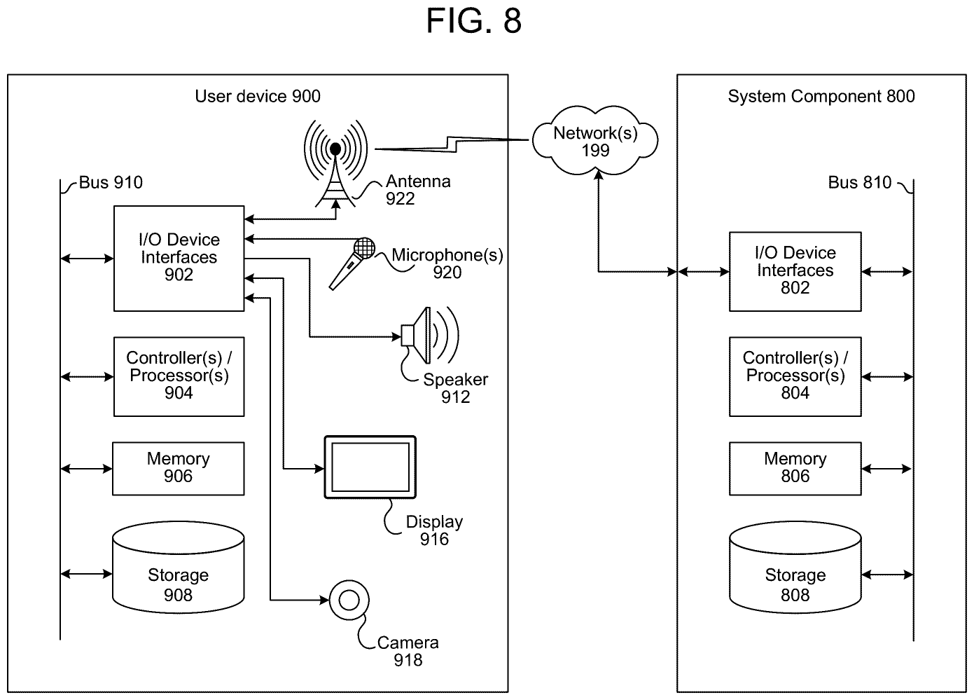

Components of the environment 100/system may include user devices 900 and/or system components 800 communicating over one or more computer networks 199 as described below with reference to FIG. 8. For example, the client device 110 and/or client device 120 may be a personal electronic device such as a mobile phone, tablet, laptop, desktop computer, etc. In some cases, the client device 110 may have an integrated camera (e.g., shown as camera 918 in FIG. 8). In some cases, the camera 101 may be a separate device from the client device 110; for example, the operator 15 may use a digital single-lens reflex (DSLR) camera 101 to capture images 105, and a separate user device 900 to upload the images 105 to the web server 130. In some cases, however, a DSLR camera 101 may include hardware and/or software capable of uploading images 105 to the web server 130 directly (e.g., allowing the camera 101 itself to also perform the operations of the client device 110).

The client device 110 may include software and/or hardware to communicate with other components/systems of the environment 100 via wired and/or wireless networks (e.g., the computer network(s) 199). For example, the client device 110 may include a browser that presents a graphical user interface (GUI) with which the operator 15 can interact with a website hosted by the web server(s) 130. The client device 110 may be capable of storing and retrieving data in the distributed ledger 140; for example, the client device 110 may store an image hash 107 of a digitally signed image 105. The client device 110 may also be capable of storing and retrieving data in the decentralized storage system 150; for example, the digitally signed image 105.

The camera 101 may be a digital camera such as DSLR, point-and-shoot, mirrorless, etc. The camera 101 may include one or more image sensors of various types including complementary metal-oxide semiconductor (CMOS), backside illuminated (BSI) CMOS, charged coupled devices (CCD), etc. The camera 101 may capture images in color and/or black and white (e.g., grayscale), and may, in some cases, capture electromagnetic radiation outside of the visible range (e.g., infrared and/or ultraviolet). A camera 101 may have certain physical characteristics that affect the images 105 it captures. Such characteristics may include physical defects such as contamination on (or in) and/or damage to optical elements such as lenses and/or mirrors. The physical defects may also be present in the image sensor, such as dirty, damaged, or dead pixels. Such defects are unique to the particular camera 101 and affect every image 105 captured. Thus, the defects can represent a “fingerprint” that can allow a particular image 105 to be matched to a particular camera 101 for purposes of certification and verification as described herein.

In some cases, a client device 110 may include a secure enclave 111. A secure enclave 111, sometimes referred to as a trusted execution environment (TEE), may be an isolated execution environment with protections against processes, applications, and potentially even the operating system. For example, private keys may be hard-coded at the hardware level to prevent exposure. The secure enclave 111 may include a separate processing and/or memory space that can perform secure operations (e.g., related to encryption/decryption) and execute applications in a manner that protects them from observation and/or manipulation by other applications executing on the client device, including those running at higher privileges. Thus, the secure enclave 111 may be secured against external threats as well as threats from other processes executing on the client device 110 itself. The secure enclave 111 may be used to, for example, digitally sign and/or calculate image hashes 107.

The web server(s) 130 may serve as a user-facing front end to provide operators 15 and requestor(s) 25 access to the system. A web server 130 may be made up of one or more system components 800 as shown in FIG. 8. The web server(s) 130 may host a website and/or expose application programming interfaces (APIs) with which the client device 110 and client device 120 may interact to register a camera 101, certify an image 105, and verify an image 105. The web server(s) 130 may send instruction to the client device 110 on how to register and, in some cases, may cause the client device 110 to perform some of the registration operations directly and/or indirectly (e.g., by providing to the client device 110 an app that can perform some of the registration and/or certification operations and/or guide the operator 15 through the registration steps). On the back end, the web server(s) 130 may interface with the trusted processing unit(s) 160 and/or nodes of the distributed ledger 140. The web server(s) 130 may send/receive data to/from the trusted processing unit(s) 160 for the purpose of training a model 125 to register a camera 101, certifying an image 105, and verifying an image 105. The web server(s) 130 may retrieve certificates 135 from to the node(s) of the distributed ledger 140, which may maintain immutable copies of the certificates 135 in addition to image hashes 107, model hashes 127, and/or public key 115b of client devices 110.

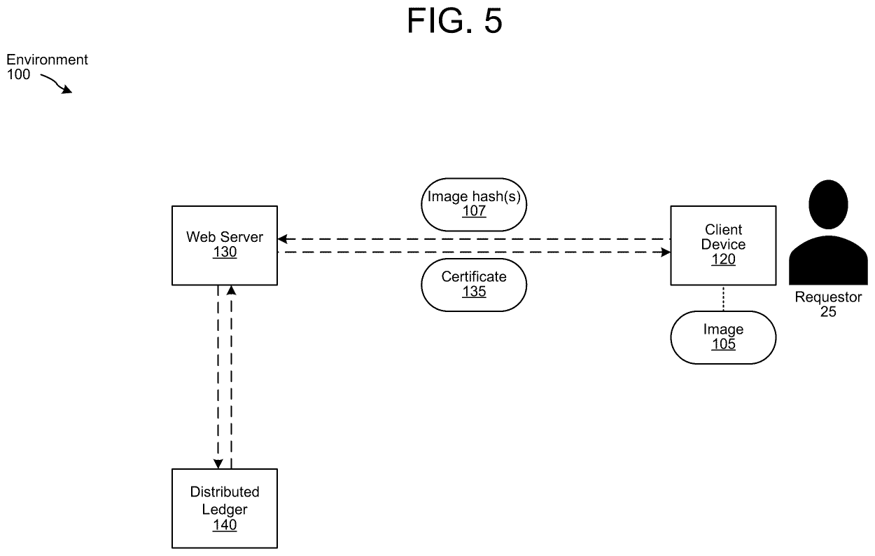

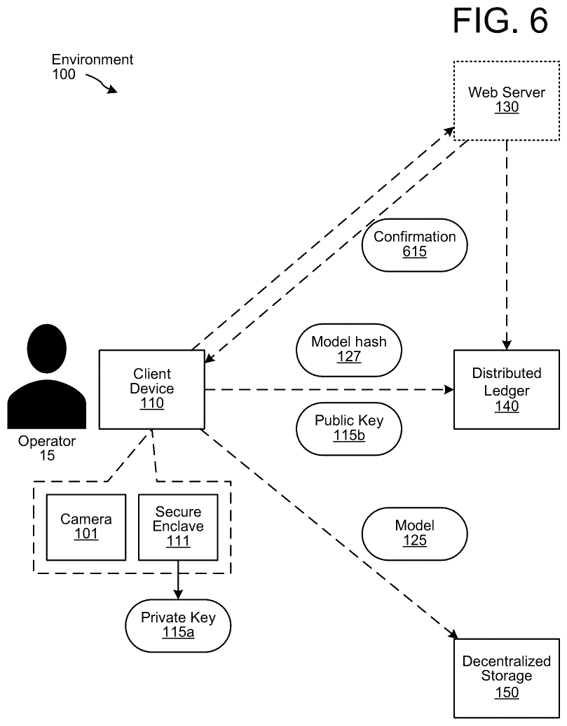

The trusted processing unit(s) 160 may represent secure computing platforms that can perform processing operations of the system such as training a model 125, using the model 125 to certify and/or verify an image 105, and prepare a ZKP and/or certificate 135 to record the authenticity of a certified/verified image 105. A trusted processing unit 160 may be made up of one or more system components 800 as shown in FIG. 8. The trusted processing unit(s) 160 may leverage the distributed ledger 140 to maintain immutable copies of image hashes 107, model hashes 127, public keys 115b of client devices 110, and/or certificates 135. The trusted processing unit(s) 160 may also store data in and/or retrieve data from the decentralized storage system 150. For example, the trusted processing unit(s) 160 may store the trained model(s) 125 in the decentralized storage system 150. While the decentralized storage system 150 may not be as secure as the trusted processing unit(s) 160 or the distributed ledger 140, the model hash 127 stored in the distributed ledger 140 can be used to retrieve the model 125 from the decentralized storage system 150 and/or verify that the model 125 has not been modified or manipulated. Similarly, the trusted processing unit(s) 160 can store images 105 in the decentralized storage system 150 and, when retrieving them, use the image hashes 107 stored in the distributed ledger 140 to verify that the images 105 have not been modified or manipulated. During certification and/or verification, the trusted processing unit(s) 160 may use the public key 115b corresponding to the client device 110 to retrieve the model hash 127 from the distributed ledger 140, and the model 125 and/or previous images 105 or extracted features therefrom. Once the trusted processing unit(s) 160 certifies an image 105, it may store the certificate 135 in the distributed ledger 140 for future retrieval by system, the client device 120, and/or other entities. Following registration, the images 105 used for training the model 125 may no longer be needed and thus may be discarded by the system (e.g., deleted from the decentralized storage system 150 and/or the trusted processing unit 160). Further details regarding operations of the trusted processing unit(s) 160 during registration of a camera 101 are described in further detail below with reference to FIGS. 2A and 2B. Further details regarding operations of the trusted processing unit(s) 160 during certification of an image 105 uploaded by the client device 110 are described in further detail below with reference to FIGS. 3A and 3B. Further details regarding operations of the trusted processing unit(s) 160 during verification of an image 105 uploaded by the client device 120 are described in further detail below with reference to FIGS. 4A and 4B. In some cases, a requestor 25 may retrieve a certificate 135 of a previously verified image 105 directly from the distributed ledger 140 as shown in FIG. 5. In some cases, an operator 15 may perform certain camera registration operations locally on the client device 110 and upload the model 125 and/or model hash 127 itself as shown in FIG. 6.

The decentralized storage system 150 may be a system and/or service for hosting data, such as images 105. For example, the decentralized storage system 150 may be a public or private “cloud” service to which the client device 110 and/or components of the system may upload data for later retrieval by themselves and/or other entities. The decentralized storage system 150 may not be a part of the system (e.g., under the same administrative control); thus, data stored in the decentralized storage system 150 may be verified using hashes stored in the distributed ledger 140. For example, an image 105 stored in the decentralized storage may have a corresponding image hash 107 stored in the distributed ledger 140, a model 125 in the decentralized storage system 150 may have a corresponding model hash 127 in the distributed ledger 140, etc. In some implementations, the decentralized storage system 150 may be a distributed file system. In some implementations, the decentralized storage system 150 may be a peer-to-peer filesharing network. In some implementations, the decentralized storage system 150 may implement a content-addressable storage (CAS), which may allow information to be retrieved based on content, rather than its name or location. An example decentralized storage system is the InterPlanetary File System (IPFS) developed by Protocol Labs of San Francisco, CA.

The system may store certain data in the distributed ledger 140. A distributed ledger represents a shared, replicated, and synchronized data store. The distributed ledger 140 may be made up of distributed nodes. The distributed nodes may execute a consensus algorithm to determine the correct updated ledger to represent the addition of new data (e.g., an image hash 107, model hash 127, and/or certificate 135, etc.). The distributed nodes may form a peer-to-peer network (e.g., within and/or across the computer network 199) to propagate updates once the correct updated ledger is determined. Each distributed node will then update itself accordingly. The result is a tamper resistant record of the received data replicated across multiple nodes and without a single point of failure.

The distributed ledger may be a linear data structure (e.g., a chain such as blockchain) or a more complex structure like a directed acyclic graph. A directed acyclic graph in the context of a distributed ledger may be made up of blocks of data and edges indicating adjacency of data blocks added to the distributed ledger. Each edge is directed, indicating a direction from an existing data block to a new data added to the existing data block. The structure is acyclic in that it contains no paths by which a data block can be crossed twice by traversing any sequence of edges according to their direction (e.g., no edges are directed “backwards” in time). A data block may, however, have multiple edges directed to it and/or away from it.

The consensus algorithm may be a proof-of-work algorithm or a proof-of-stake algorithm. A proof-of-work algorithm is a form of cryptographic proof a party can use to prove to others that it has performed a certain about of computational work. The proof is asymmetric in that a verifier may confirm the proof with minimal computational effort. An example of proof-of-work in the context of distributed ledgers is “mining” for cryptocurrency, where mining refers to the incentive structure used to encourage nodes to expend computational effort to add data blocks to the distributed ledger. In contrast, proof-of-stake protocols only allow nodes owning some quantity of data blocks (e.g., blockchain tokens) to validate and add new data blocks. Proof-of-stake protocols prevent attackers from hijacking validation by requiring an attacker to acquire a large proportion of data blocks. Proof-of-stake protocols include, for example, committee-based proof of stake, delegated proof of stake, liquid proof of stake, etc.

Distributed ledgers may be permissioned or permissionless. A permissioned distributed ledger may refer to a private system having a central authority for authorizing nodes to add data blocks. In some cases, a consortium may agree to operate a distributed ledger jointly among the participating organizations while excluding others. A permissionless distributed ledger may refer to an open or public network for which no access control is used. Any party may add to the distributed ledger, provided they satisfy the consensus algorithm (e.g., proof of work). An example of a permissionless distributed ledger is bitcoin and other cryptocurrencies that require new entries include a proof of work.

FIG. 2A is a conceptual diagram illustrating example operations of registering a camera using the system, according to embodiments of the present disclosure. The operator 15 may use the client device 110 to send a registration request 205 for the camera 101 to the web server(s) 130. The web server 130 may provide the client device 110 with instructions on how to register the camera 101 (e.g., by providing written instructions and/or an app to guide the operator 15 through the registration process). The operator 15 may use the camera 101 to capture images 105. The operator 15 may use the client device 110 to digitally sign the images 105 using a private key 115a. The operator 15 may use the client device 110 to upload the digitally signed images 105 and a public key 115b corresponding to the private key 115a to the decentralized storage system 150. In some implementations, the client device 110 may record the public key 115b in the image 105 metadata. In some implementations, the client device 110 may calculate image hashes 107 and upload the image hashes 107 to the distributed ledger 140.

The web server 130 may forward the registration request 205 to the trusted processing unit(s) 160. The trusted processing unit 160 may retrieve the images 105 and the public key 115b from the decentralized storage system 150 and verify that the images 105 are properly signed. The trusted processing unit 160 may retrieve the image hashes 107 from the distributed ledger 140 and verify that the images 105 have not been modified. If the images 105 pass the preceding verifications, the trusted processing unit 160 may use the images 105 to train a machine learning model 125 to determine whether an image 105 originated from (e.g., was captured by) the camera 101. The machine learning model may include, for example a convolutional neural network (CNN). The trusted processing unit 160 may use the images 105 to train the machine learning model 125 to extract features that may be unique to the camera 101, such as physical defects and/or subtle features. Physical defects may include dead pixels, hot pixels, optical imperfections (e.g., dust, scratches, inclusions, and/or other variations on or in optical components such as lenses, mirrors, prisms, color filters, etc.) and may be directly detected using image analysis techniques. Subtle features may be captured using wavelet analysis, Fourier transforms, and/or statistical analysis of image noise. Training of the machine learning model 125 may include supervised and/or unsupervised learning. For example, the trusted processing unit 160 may train the machine learning model 125 to correctly correlate image data from different cameras to the originating camera. Alternatively or additionally, the machine learning model 125 may be configured as an autoencoder, and trained by the trusted processing unit 160 to reproduce the camera-specific features. The encoder of the autoencoder, so trained, may be used to process images 105 to determine an embedding representing the camera-specific features. For new images 105 to be certified and/or verified, the system may use the encoder to determine an embedding for a given image 105, and match the embedding against a reference embedding for the camera 101.

In some implementations, the client device 110 may be capable of training the model 125 itself; that is, without relying on the trusted processing unit 160. In such cases, the client device 110 may register itself with the distributed ledger 140 as described below with reference to FIG. 6.

In implementations in which the trusted processing unit 160 trains the model 125, the trusted processing unit 160 may upload the trained machine learning model 125 to the decentralized storage system 150. The trusted processing unit 160 may use the model 125 to calculate a model hash 127. The trusted processing unit 160 may associate the model hash 127 using the public key 115b and upload the model hash 127 to the distributed ledger 140. This may allow the trusted processing unit 160 to retrieve the model hash 127 from the distributed ledger 140 using the public key 115b and use the model hash 127 to retrieve the model 125 from the decentralized storage system 150. The trusted processing unit 160 may then use the retrieved model 125 to calculate a probability that a subsequently received image 105 and public key 115b corresponds to the particular camera 101 registered using that public key 115b.

If registration is successful, the trusted processing unit 160 may return a registration confirmation 215 to the web server 130, which may forward the registration confirmation 215 to the client device 110. To record camera 101 registration using the distributed ledger 140, the system may use a unique camera identifier and a hash of the model. The system may use the unique camera identifier to distinguish the camera 101 from other cameras. The unique camera identifier may include, for example, the public key 115b. The system may use the model hash 127 stored in the distributed ledger 140 to ensure that that the correct and original model 125 is used for certification/verification of images 105 from the corresponding camera 101. The system may register the two elements in the distributed ledger 140 using a smart contract. This process can create a permanent and tamper-proof record of the camera 101 and its corresponding model 125. The smart contract may also produce a ZKP as evidence of registration, confirming that the camera 101 and model 125 are linked (e.g., that the model 125 was correctly trained on the submitted images 105 from the camera 101), but without revealing sensitive information (e.g., such as the images 105 used to train the model 125 and/or parameters of the trained model 125). The ZKP of successful registration may serve as a record that the camera 101 has been registered using the public key 115b.

FIG. 2B is a signal flow diagram illustrating example operations of registering the camera, according to embodiments of the present disclosure. The client device 110 may send (202) a registration request 205 to the web server(s) 130. The web server 130 may return (204) to the client device 110 registration instructions. The operator 15 may use the camera 101 to capture images 105 and use the client device 110 to digitally sign them using the private key 115a (206). The client device 110 may upload (208) the images 105 to the decentralized storage system 150. The client device 110 may calculate image hashes 107 and upload (210) them to the distributed ledger 140. The web server 130 may forward (212) the registration request 205 to the trusted processing unit(s) 160. The trusted processing unit 160 may receive the registration request 205 an commence registration processing. The trusted processing unit 160 may retrieve (216) the images 105 from the decentralized storage system 150 and retrieve (218) the image hashes 107 from the distributed ledger 140. The trusted processing unit 160 may verify the images 105 using the public key 115b and the image hashes 107. The trusted processing unit 160 may use the verified images 105 to train (220) the machine learning model 125. The trusted processing unit 160 may upload (222) the trained model 125 to the decentralized storage system 150. The trusted processing unit 160 may also calculate a model hash 127 and upload (224) it to the distributed ledger 140. in some implementations, the trusted processing unit 160 may calculate (226) a ZKP of successful registration and publish (228) the ZKP to the distributed ledger 140. The trusted processing unit 160 may then send (230) a confirmation 215 of registration to the web server 130, which may forward (232) the confirmation 215 to the client device 110.

FIG. 3A is a conceptual diagram illustrating example operations of using the system to certify that an image 105 originated from the camera 101 belonging to the operator 15, according to embodiments of the present disclosure. After registering the camera 101, the operator 15 may use the system to certify an image 105 captured using the camera 101. If the certification process succeeds, the system may create a certificate 135 that can be stored in the distributed ledger 140, returned to the client device 110, and/or a third-party requestor 25. The certificate 135 may be a data file that may include the image hash 107 of the image 105, a ZKP of successful certification, and/or a score representing a probability that the camera 101 captured the image 105 (e.g., as determined by the trained model 125). In some cases, the certificate 135 may additionally include the public key 115b of the client device 110 associated with the camera 101.

The operator 15 may capture an image 105 using the camera 101. The operator 15 may use the client device 110 to digitally sign the image 105 using the private key 115a and upload the digitally signed image 105 to the web server(s) 130 along with the public key 115b and a certification request 305. The client device 110 may record the public key 115b in the image 105 metadata and/or include it in the certification request 305. The web server 130 may forward the certification request 305, image 105, and public key 115b to the trusted processing unit(s) 160.

The trusted processing unit 160 may use the public key 115b to verify that the digital signature in the image 105. Because verifying the digital signature does not include using any private data or processes (e.g., the model 125), however, in some implementations the web server 130 may verify the digital signature prior to forwarding the certification request 305 to the trusted processing unit. The trusted processing unit 160 may use the public key 115b to retrieve the corresponding model hash 127 from the distributed ledger 140 (e.g., the model hash 127 corresponding to the same client device 110/camera 101 as the public key 115b). The trusted processing unit 160 may use the model hash 127 to retrieve, from the decentralized storage system 150, the model 125 corresponding to the camera 101. The trusted processing unit 160 may process the image 105 using the model 125 to determine a probability (e.g., a score) that the image 105 originated from the camera 101. The trusted processing unit 160 may determine whether the probability satisfies a condition; for example, whether the probability exceeds a threshold representing a minimum confidence score that the image 105 originated from the camera 101. If the probability exceeds the threshold, the trusted processing unit 160 may create the certificate 135 and record it in the distributed ledger 140.

In some implementations, the trusted processing unit 160 may implement a mechanism to protect against an adversarial attack. In an adversarial attack, an attacker may use a generative model or other software to generate many images 105 with noise added to each. The noise may be imperceptible to a human or image processing software. If an attacker floods the system with enough spurious images, the attacker may eventually discover a modification that can trick the model 125 into assigning a high probability that the particular image 105 originated from the registered camera 101. In most cases, however, images captured in rapid succession will differ due to movement of the subjects, background, and/or the camera 101 itself between successive images. The system may shield itself from an adversarial attack by comparing an image 105 against other recently received images 105. The system may use similarity metrics such as structural similarity index (SSIM), peak signal-to-noise ratio (PSNR), and/or other learned metrics to detect manipulated duplicates of images 105. If the images exhibit a sufficiently high similarity, the system may determine that images 105 likely represent manipulated duplicates. For example, the trusted processing unit 160 may extract features 307 from the image 105. To extract the features 307, the trusted processing unit 160 may use software and/or a machine learning model that has been trained to extract information relevant to differentiating between similar images 105 legitimately captured in rapid sequence and manipulated duplicate images 105. The features 307 may be represented in the form of, for example, a feature vector or other type of data structure. The trusted processing unit 160 may store the features 307 in the decentralized storage system 150 for use in evaluating subsequently received images 105. To assess the current image 105, the trusted processing unit 160 may retrieve historical image features 309 corresponding to previously received images 105. The historical image features 309 may include features from images 105 received in the previous few seconds to few minutes. In some cases, the historical image features 309 may represent a predetermined window of time (e.g., half a minute to several minutes) or a predetermined number of historical images 105 (e.g., 4, 8, 16, etc.). The trusted processing unit 160 may calculate a distance between the image features 307 and the historical image features 309. The trusted processing unit 160 may determine a score representing the dissimilarity of the image features. The trusted processing unit 160 may determine whether the score satisfies a condition (e.g., is below a threshold). The score may be, for example, a probability that the image 105 is authentic. If the trusted processing unit 160 determines that the images are too similar (e.g., the probability is below a threshold), the trusted processing unit 160 may halt verification and return a failure notification. If the probability exceeds the threshold, the trusted processing unit 160 may continue certification processing. In some implementations, the trusted processing unit 160 may check for evidence of an adversarial attack after verifying the digital signature but before processing the image 105 using the model 125. In some implementations, the trusted processing unit 160 may perform the checks in a different order. In some implementations, the trusted processing unit 160 may

In some implementations, the trusted processing unit 160 may calculate a ZKP that the system successfully certified that the image 105 originated from the camera 101. The ZKP may serve to certify that an image 105, used as input to the model 125, resulted in a match; in other words, that the image 105 exhibits the characteristics of the camera 101. In various implementations, the model 125 may be run in a secure enclave such as the trusted processing unit 160. In some cases, if the system is capable of executing the model 125 in a secure enclave, the system may not generate a ZKP. In implementations in which the system computes a ZKP, the system may compute the ZKP in the secure enclave and/or in a zero-knowledge virtual machine (zkVM). The trusted processing unit 160 can include the ZKP in the certificate 135 as proof that the model 125 determined that the image 105 is likely authentic, without having to expose the model 125 itself (which could allow an attacker to engineer an image manipulator that could fool the model 125 into believing a spurious image was captured from the camera 101). For example, the trusted processing unit 160 may generate the probability statements (e.g., that the camera model 125 indicates a high likelihood of authenticity while the anti-attack model indicates a low likelihood of adversarial manipulation) using zero-knowledge machine learning (zkML) from a zkVM. The use of zkML and/or a zkVM may generate the ZKP indicating that the computation(s) can be trusted.

In various implementations, the ZKP of image certification/verification may be computed in different ways. In a first example implementation, the trusted processing unit 160 may run an executable program that can securely sign a result and produce a ZKP of model execution. To securely sign the result, the trusted processing unit 160 may have a secure enclave in which it can execute the model 125 to process the image 105. Additionally or alternatively, the trusted processing unit 160 may include one or more central processing units (CPUs) equipped with a trusted platform module (TPM). Use of the TPM may allow an auditor to verify that the executable running in the TPM matches a known version identified by a signature produced in the secure enclave and/or by the TPM. The trusted processing unit 160 may produce the ZKP that the model 125 was executed with a known image 105 as input; for example, by representing the image hash 107 and the inference result in the ZKP output. The trusted processing unit 160 may use a zero-knowledge scalable transparent argument of knowledge (ZK-STARK) to run the following function in a verifiable way:

### P(Image, Inference_Result)→Inference_Result, Hash(Image)

Where Image may be a byte array of arbitrary size, Inference_Result is a binary value representing the result of the inference, and Hash is a cryptographic hash function (e.g., SHA384 or the like). In this situation, the inference result may be passed as an input to a proof function. The inference executable may be trusted to run the prover while honestly passing the correct result and image.

In a second example implementation, the ZKP may rely on execution of the model 125 in a zkVM that is capable of running an inference in a verifiable way. Such a zkVM can produce a zero-knowledge succinct non-interactive argument of knowledge (ZK-SNARK). Because ZK-SNARK involves a trusted setup, creating the proof of inference may include creating a common reference string (CRS). A CRS may be produced using a multi-party computation (MPC) using a ledger (e.g., the distributed ledger 140). The trusted processing unit 160 and a client device (e.g., the client device 110 and/or the client device 120) may engage in the MPC, which results in a CRS. The trusted processing unit 160 may execute the inference using the model 125 and process the image 105 to determine the image hash 107 in a single proof circuit. This may produce the ZK-SNARK proving that the model 125 processed the image 105 to generate an inference result visible as proof output, and the same image 105 was hashed with the image hash 107 also visible as proof of output.

### P(Image)→Infer(Image), Hash(Image)

Regardless of the type of proof, the trusted processing unit 160 may write a record on the ledger that includes the proof of inference and a reference to the camera 101 and model hash 127 registration. The trusted processing unit 160 can certify that a particular model 125, created for a particular camera 101, was used for inference. Additionally, the proof of inference may be associated with the model 125 used for the inference.

Once the trusted processing unit 160 has certified the image 105, it may return a confirmation 315 to the web server 130. The web server 130 may, based on the confirmation 315, retrieve the certificate 135 from the distributed ledger 140, and forward the certificate 135 to the client device 110. The system may also make the certificate 135 available to other requestors 25 who request verification of the image 105. In the event that the image 105 does not pass one of the checks implemented by the trusted processing unit 160 (e.g., relating to the digital signature, probability determined by the model 125, and/or probability of an adversarial copy, etc.), the web server 130 may return an error message to the operator 15.

FIG. 3B is a signal flow diagram illustrating example operations of certifying the image 105, according to embodiments of the present disclosure. The operator 15 may use the camera 101 to capture (302) an image 105. The operator 15 may use the client device 110 to apply (304) a digital signature using the private key 115a. The operator 15 may use the client device 110 to send (306) a certification request 305 to the web server(s) 130. The client device 110 may include the digitally signed image 105 and the public key 115b. The web server 130 may forward (308) the certification request 305 (and the image 105 and public key 115b) to the trusted processing unit(s) 160. In some implementations, the web server 130 may verify the digital signature of the image 105 using the public key 115b; in other implementations, the trusted processing unit 160 may verify the digital signature.

The trusted processing unit 160 may process (310) the image 105 to extract features 307. The trusted processing unit 160 may store (312) the features 307 in the decentralized storage system 150 (e.g., for future use with the anti-attack mechanism). The trusted processing unit 160 may use the public key 115b to retrieve (314) the model hash 127 from the distributed ledger 140. The trusted processing unit 160 may use the model hash 127 to retrieve (316) the model 125 from the decentralized storage system 150. The trusted processing unit 160 may determine (318) at this stage whether the same public key 115b corresponds to the image 105 and the model 125. If not, the system may return (320) a failure notification and cease certification operations. If the keys match, the trusted processing unit 160 may continue with the certification operations.

In some implementations, the trusted processing unit 160 may perform an anti-attack check here. The trusted processing unit 160 may retrieve (322) historical image features 309 from the decentralized storage system 150. The trusted processing unit 160 may compare the image features 307 and the historical image features 309 to calculate (324) a probability that the image 105 is part of an adversarial attack (e.g., based on a similarity between the current image features 307 and historical image features 309 as previously described). If the trusted processing unit 160 computes a high probability that the image 105 is part of an adversarial attack, it may return (326) a failure notification and cease certification operations. If the computed probability is below threshold, the trusted processing unit 160 may continue with the certification operations.

The trusted processing unit 160 may determine (328) whether the model 125 indicates a match between the image 105 and the camera 101. For example, trusted processing unit 160 may process the image 105 using the model 125 and determine a probability that the image 105 originated from the camera 101. If the probability of a match is low, the system may return (330) a failure notification and cease certification operations. If the computed probability exceeds the threshold, the trusted processing unit 160 may continue the certification operations.

The trusted processing unit 160 may create (332) a ZKP that the system has processed the image 105 using the model 125 to determine that the image 105 is authentic and originated from the camera 101. The trusted processing unit 160 may create a certificate 135 indicating the origin and authenticity of the image 105, and record (334) it in the distributed ledger 140. The trusted processing unit 160 may send (336) a confirmation 315 of successful certification to the web server 130. The web server 130 may retrieve (338) the certificate 135 and provide (340) it to the client device 110. In some cases, client device 110 may receive the certificate 135 in other ways; for example, from the trusted processing unit 160 by way of the web server 130 directly, from the distributed ledger 140 directly, or by some other means. In addition, the system may provide the certificate 135 in response to a request to verify the same image 105 in the future.

FIG. 4A is a conceptual diagram illustrating example operations of using the system to verify that an image 105 originated from a particular camera 101, according to embodiments of the present disclosure. Verification operations are similar to the certification operations described above with a couple of differences. First, a verification request 405 may originate from a requestor 25 and a client device 120 unassociated with the operator 15, client device 110, and/or the camera 101. Rather, the requestor 25 may have obtained the image 105 by other means (e.g., found on the web, received in an email or message, etc.). Second, the system may check to see if the image 105 has already been certified, in which case the system can bypass much of the certification processing and return the previously created certificate 135.

The requestor 25 may upload an image 105 to the web server(s) 130 with a verification request 405. The verification request 405 may include a public key 115b, or the image 105 may include the public key 115b in its metadata. The system may calculate an image hash 107 of the image 105 and use the image hash 107 to locate a corresponding certificate 135 in the distributed ledger 140. If the system locates a match, the system may return the certificate 135 to the client device 120. If the system does not find a match, it may proceed with the verification operations. In some implementations, for an image 105 previously certified, the requestor 25 may retrieve the corresponding certificate 135 from the distributed ledger 140 directly as described below with reference to FIG. 5.

The web server 130 may forward the verification request 405, the image 105, and the public key 115b to the trusted processing unit 160. Using operations similar to the certification processes described above, the trusted processing unit 160 may use the public key 115b to retrieve a corresponding model hash 127 from the distributed ledger 140, use the model hash 127 to retrieve the corresponding model 125 from the decentralized storage system 150, and verify that the same public key 115b corresponds to the image 105 and the model 125. The trusted processing unit 160 may process the image 105 using the model 125 to determine a match probability (e.g., that the image 105 originated from the camera 101 corresponding to the model 125). In some implementations, the trusted processing unit 160 may compare image features 307 extracted from the image 105 with historical image features 309 retrieved from the decentralized storage system 150 to determine a probability that the image 105 is part of an adversarial attack. If all certification steps succeed, the trusted processing unit 160 may compute a ZKP of successful verification and record a certificate 135 in the distributed ledger 140. The trusted processing unit 160 may return a confirmation 415 to the web server 130. The web server 130 may retrieve the certificate 135 and send it to the client device 120.

FIG. 4B is a signal flow diagram illustrating example operations of verifying the image 105, according to embodiments of the present disclosure. The requestor 25 may use the client device 120 to send (402) the verification request 405 to the web server(s) 130 (e.g., accompanied by the image 105 and the public key 115b). The trusted processing unit(s) 160 may calculate an image hash 107 of the image 105 and determine (404) whether the image hash 107 corresponds to a previously created certificate 135 in the distributed ledger 140. If so, the trusted processing unit 160 may retrieve (406) the certificate 135 and return (408) to the client device 120; for example, either directly, via the web server 130, or by some other means. If the trusted processing unit 160 does not identify a certificate 135 matching the image hash 107, the verification operations may continue with Stages 410 through 434. The Stages 410 through 434 may be same as or similar to the Stages 310 through 334 of the certification operations shown in FIG. 3B. If any of the verification/certification checks fail, the system may return a notification to the client device 120 that the image 105 could not be verified. If the system determines that all of the verification/certification checks succeed for the image 105, the trusted processing unit 160 may send (436) a confirmation 415 of successful verification to the web server 130. The web server 130 may retrieve (438) the certificate 135 and provide (440) it to the client device 110. In some cases, client device 110 may receive the certificate 135 in other ways; for example, from the trusted processing unit 160 by way of the web server 130 directly, from the distributed ledger 140 directly, or by some other means. In addition, the system may provide the certificate 135 in response to a request to verify the same image 105 in the future.

FIG. 5 is a conceptual diagram illustrating example operations of a requestor 25 obtaining a certificate 135 for an image 105 from the distributed ledger 140, according to embodiments of the present disclosure. In some cases, a client device 120 may have the ability to compute an image hash 107 and verify a ZKP. In such cases, the requestor 25 may obtain an image 105, use the client device 120 to calculate the image hash 107, and use the image hash 107 to retrieve the corresponding certificate 135 from the distributed ledger 140. In some cases, the client device 120 may interface with the distributed ledger 140 directly. In some cases, the client device 120 may optionally use the web server 130 to retrieve the certificate from the distributed ledger 140. When the client device 120 receives the certificate 135, it may verify the ZKP recorded in the certificate 135 to determine that the image 105 corresponding to the image hash 107 was properly certified using the model 125 corresponding to the camera 101. The camera 101 may be specified by a unique identifier, for example, the public key 115b, also recorded in the certificate 135. Thus, the requestor 25 may be able to verify the image 105 without the use of the trusted processing unit 160 (and, in some cases, the web server 130).

FIG. 6 is a conceptual diagram illustrating example operations of registering a camera 101 by training a model 125 using the client device 110 and recording the model hash 127 and the client device's public key 115b in the distributed ledger 140, according to embodiments of the present disclosure. In some implementations, the client device 110 may be capable of training the model 125 itself; that is, without relying on the trusted processing unit 160. In such cases, the client device 110 may register itself with the distributed ledger 140 directly. The client device 110 may train the model 125 using images 105 captured from the camera 101. To train the model 125, the client device 110 may download an application or app from the web server 130. The app may include an initialized model and an executable program for training the initialized model to learn the model 125 specific to the camera 101. The client device 110 may run the executable in the secure enclave 111 and/or a trusted processing unit (e.g., similar to the trusted processing unit 160) internal to the client device 110. The executable may additionally calculate a model hash 127 of the trained model 125. The client device 110 may associate the model hash 127 with the public key 115b, and record the association in the distributed ledger 140 (either directly and/or via the web server 130). If the client device 110 registers the camera 101 via the web server 130, the web server 130 may return a confirmation 615, similar to the operations shown in FIGS. 2A and 2B. The client device 110 may store the model 125 in the decentralized storage system 150. This manner of direct registration by the client device 110 may offer advantages over registration using the trusted processing unit 160 because the client device 110 may not have to upload images 105 to the cloud. The trusted processing unit 160 may retrieve the model hash 127 and the model 125 as previously described to verify images 105 associated with the public key 115b.

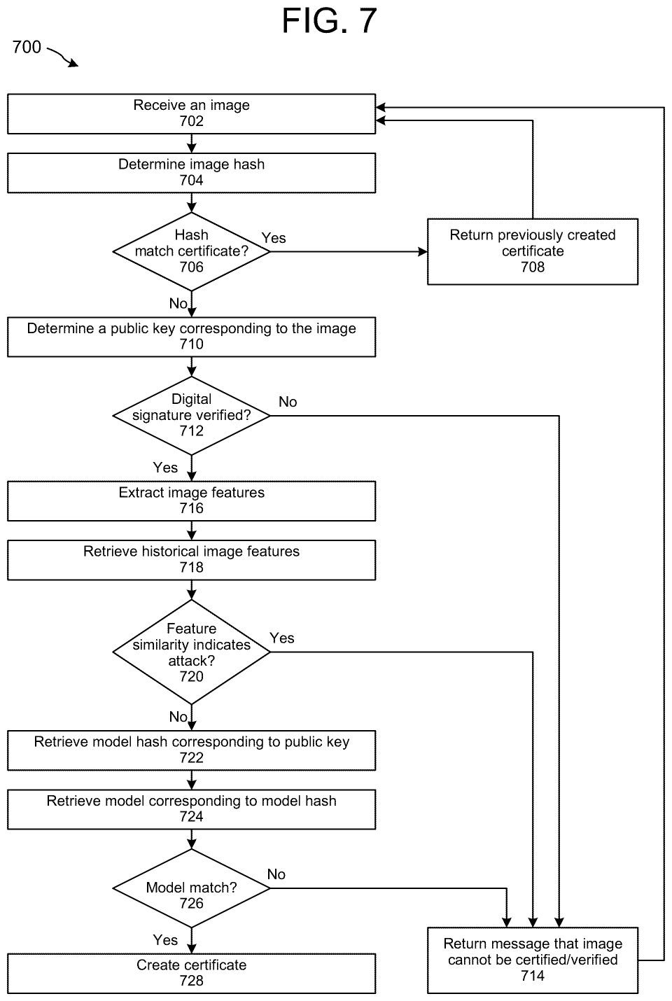

FIG. 7 is a flowchart illustrating an example method 700 of the system, according to embodiments of the present disclosure. The system may use the method 700 to certify and/or verify an image 105 uploaded to the system. The method 700 may include receiving (702) an image 105. The system may receive the image 105 from a client device 110 (e.g., for certification) or a client device 120 (e.g., for verification). The method 700 may include determining (704) an image hash 107 of the image 105. The method 700 may include determining (706) whether the image hash 107 matches a previously created certificate 135 (e.g., stored in the distributed ledger 140). If so (“Yes” at 706), the method 700 may proceed to Stage 708 and return the previously created certificate. After Stage 708, the method 700 may end or suspend until it the system receives another image 105 for certification/verification. If not (“No” at 706), the method 700 may proceed to Stage 710.

The method 700 may include determining (710) a public key 115b corresponding to the image 105; for example, by reading it from the image 105 metadata. The method 700 may include verifying (712) the digital signature of the image 105. If the system is unable to verify, using the public key 115b, that the image 105 was properly signed using the corresponding private key 115a (“No” at 712), the method 700 may proceed to Stage 714 and return a message that the image 105 could not be certified or verified (e.g., as originating from a camera 101 corresponding to the public key 115b). After Stage 714, the method 700 may end or suspend until it the system receives another image 105 for certification/verification. If the system verifies that the image 105 was properly signed using the corresponding private key 115a (“Yes” at 712), the method 700 may proceed to Stage 716.

The method 700 may include extracting (716) image features 307 from the image 105. The method 700 may include retrieving (718) historical image features 309 (e.g., from the decentralized storage system 150). The method 700 may include comparing the image features 307 with the historical image features 309 to determine (720) whether similarity between the two indicates a likelihood that the image 105 indicates an adversarial attack. If the system determines that the similarity indicates a likely attack (“Yes” at 720), the method 700 may proceed to Stage 714 and return a message that the image 105 cannot be certified/verified. In some implementations, however, the system may not return any message to the device that sent the certification/verification request but may simply cease processing with respect to the image 105. In some implementations, the system may issue a notification or alert indicating detection of a possible adversarial attack. If the system determines that the image 105 likely does not correspond to an attack (“No” at 720), the method 700 may proceed to Stage 722.

The method 700 may include retrieving (722) a model hash 127 corresponding to the public key 115b (e.g., from the distributed ledger 140). The method 700 may include using the model hash 127 to retrieve (724) the model 125 (e.g., from the decentralized storage system 150). In some implementations, the system may verify that the same public key 115b was used for the image 105 and the model 125. The method 700 may include processing the image 105 using the model 125 to determine (726) whether the image 105 likely matches the images used to train the model 125 (e.g., indicating a probability that the image 105 originated from the camera 101 corresponding to the model 125). If the model 125 determines that the probability of a match is less than a threshold (“No” at 726), the method 700 may proceed to Stage 714 and return a message that the image 105 cannot be certified/verified. If the model 125 determines that the probability exceeds the threshold (“Yes” at 726), the method 700 may proceed to Stage 728. The method 700 may include creating (728) a certificate 135. The system may store the certificate 135 in the distributed ledger 140 and/or return it to the client device 110 or 120 that submitted the image 105 for certification/verification.

In various implementations, the method 700 may include more, fewer, and/or different stages than those shown in FIG. 7. In various implementations, stages may be omitted, modified, duplicated, performed in different orders, and/or performed partially or completely in parallel.

FIG. 8 is a block diagram illustrating an example user device 900 and system component 800 communicating over a computer network 199, according to embodiments of the present disclosure. In some implementations, the client device(s) 110 and/or 120 may be a user device 900 as a shown in FIG. 8. In some implementations, the client device(s) 110 and/or 120 may be a system component 800 as shown in FIG. 8 and/or a virtual machine executing on one or more system components 800. One or more system components 800 may make up one or more of the components described in the example environment 100. For example, the web server(s) 130, trusted processing unit(s) 160, nodes of the distributed ledger 140, and/or the decentralized storage system 150 may be made up of (and/or execute on) one or more system component 800.

While the user device 900 may operate locally to an operator 15 and/or requestor 25 (e.g., within a same environment so the device may receive inputs and playback outputs for the requestor) the system component(s) 800 may be located remotely from the user device 900 as its operations may not require proximity to the requestor. The system component(s) may be located in an entirely different location from the user device 900 (for example, as part of a cloud computing system or the like) or may be located in a same environment as the user device 900 but physically separated therefrom (for example a home server or similar device that resides in a requestors home or office but perhaps in a closet, basement, attic, or the like). In some implementations, the system component(s) 800 may also be a version of a user device 900 that includes different (e.g., more) processing capabilities than other user device(s) 900 in a home/office. One benefit to the system component(s) 800 being in a requestor's home/office is that data used to process a command/return a response may be kept within the requestor's home/office, thus reducing potential privacy concerns.

The user device 900 may include one or more controllers/processors 904, which may each include a central processing unit (CPU) for processing data and computer-readable instructions, and a memory 906 for storing data and instructions of the respective device. The memories 906 may individually include volatile random-access memory (RAM), non-volatile read only memory (ROM), non-volatile magnetoresistive memory (MRAM), and/or other types of memory. User device 900 may also include a data storage component 908 for storing data and controller/processor-executable instructions. Each data storage component 908 may individually include one or more non-volatile storage types such as magnetic storage, optical storage, solid-state storage, etc. User device 900 may also be connected to removable or external non-volatile memory and/or storage (such as a removable memory card, memory key drive, networked storage, etc.) through respective input/output device interfaces 902.

Computer instructions for operating user device 900 and its various components may be executed by the respective device's controller(s)/processor(s) 904, using the memory 906 as temporary “working” storage at runtime. A device's computer instructions may be stored in a non-transitory manner in non-volatile memory 906, data storage component 908, or an external device(s). Alternatively, some or all of the executable instructions may be embedded in hardware or firmware on the respective device in addition to or instead of software.

User device 900 includes input/output device interfaces 902. A variety of components may be connected through the input/output device interfaces 902, as will be discussed further below. Additionally, user device 900 may include an address/data bus 910 for conveying data among components of the respective device. Each component within a user device 900 may also be directly connected to other components in addition to (or instead of) being connected to other components across the bus 910.

The user device 900 may include input/output device interfaces 902 that connect to a variety of components such as an audio output component such as a speaker 912, a wired headset or a wireless headset (not illustrated), or other component capable of outputting audio. The user device 900 may also include an audio capture component. The audio capture component may be, for example, a microphone 920 or array of microphones, a wired headset or a wireless headset (not illustrated), etc. If an array of microphones is included, approximate distance to a sound's point of origin may be determined by acoustic localization based on time and amplitude differences between sounds captured by different microphones of the array. The user device 900 may additionally include a display 916 for displaying content. The user device 900 may further include a camera 918.

Via antenna(s) 922, the input/output device interfaces 902 may connect to one or more computer networks 199 via a wireless local area network (WLAN) (such as Wi-Fi) radio, Bluetooth, and/or wireless network radio, such as a radio capable of communication with a wireless communication network such as a Long-Term Evolution (LTE) network, WiMAX network, 3G network, 4G network, 5G network, etc. A wired connection such as Ethernet may also be supported. Through the network(s) 199, the system may be distributed across a networked environment. The I/O device interface 902 may also include communication components that allow data to be exchanged between devices such as different physical servers in a collection of servers or other components.

The system component 800 may include one or more physical devices and/or one or more virtual devices, such as virtual systems that run in a cloud server or similar environment. The system component 800 may include one or more input/output device interfaces 802 and controllers/processors 804. The system component 800 may further include a memory 806 and storage 808. A bus 810 may allow the input/output device interfaces 802, controllers/processors 804, memory 806, and storage 808 to communicate with each other; the components may instead or in addition be directly connected to each other or be connected via a different bus.

A variety of components may be connected through the input/output device interfaces 802. For example, the input/output device interfaces 802 may be used to connect to the computer network 199. Further components include keyboards, mice, displays, touchscreens, microphones, speakers, and any other type of user input/output device. The components may further include USB drives, removable hard drives, or any other type of removable storage.

The controllers/processors 804 may processes data and computer-readable instructions and may include a general-purpose central-processing unit, a specific-purpose processor such as a graphics processor, a digital-signal processor, an application-specific integrated circuit, a microcontroller, or any other type of controller or processor. The memory 806 may include volatile random-access memory (RAM), non-volatile read only memory (ROM), non-volatile magnetoresistive (MRAM), and/or other types of memory. The memory 806 may be used for storing data and controller/processor-executable instructions on one or more non-volatile storage types, such as magnetic storage, optical storage, solid-state storage, etc.

Computer instructions for operating the system component 800 and its various components may be executed by the controller(s)/processor(s) 804 using the memory 806 as temporary “working” storage at runtime. The computer instructions may be stored in a non-transitory manner in the memory 806, storage 808, and/or an external device(s). Alternatively, some or all of the executable instructions may be embedded in hardware or firmware on the respective device in addition to or instead of software.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers and data processing should recognize that components and process steps described herein may be interchangeable with other components or steps, or combinations of components or steps, and still achieve the benefits and advantages of the present disclosure. Moreover, it should be apparent to one skilled in the art that the disclosure may be practiced without some or all of the specific details and steps disclosed herein.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid-state memory, flash drive, removable disk, and/or other media. In addition, components of one or more of the modules and engines may be implemented as in firmware or hardware.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. As used in this disclosure, the term “a” or “one” may include one or more items unless specifically stated otherwise. Further, the phrase “based on” is intended to mean “based at least in part on” unless specifically stated otherwise.

What is claimed is:

1. A computer-implemented method comprising:
receiving first image data representing a first plurality of images captured using a first camera;
receiving a public key corresponding to a first user device;
verifying, using the public key, that the first image data was digitally signed using a private key corresponding to the public key;
training a first machine learning model using the first image data to identify first features corresponding to the first camera, the first features resulting from physical defects of the first camera;
associating the first machine learning model with the public key;
receiving a first request to verify second image data corresponding to the public key;
verifying, using the public key, that the second image data was digitally signed using the private key;
retrieving the first machine learning model using the public key; and
using the first machine learning model to determine a first probability that a first image was captured using the first camera.

2. The computer-implemented method of claim 1, further comprising:
determining that the first probability satisfies a first condition; and
based at least on determining that the first probability satisfies the first condition, determining first certification data indicating that the first image data originated from the first camera.

3. The computer-implemented method of claim 2, further comprising:
storing the first certification data in a distributed ledger.

4. The computer-implemented method of claim 1, further comprising:
prior to receiving the first request:
storing, in a decentralized storage system, first model data corresponding to the first machine learning model,
determining first model hash data corresponding to the first model hash data, and
storing the first model hash data in a distributed ledger.

5. The computer-implemented method of claim 4, further comprising:
retrieving, using the public key, the first model hash data from the distributed ledger; and
retrieving, using the first model hash data, the first model data from the decentralized storage system.

6. The computer-implemented method of claim 1, further comprising:
receiving a second request for verification that third image data originated from the first camera, the third image data corresponding to the public key;
determining first feature data representing first image features extracted from fourth image data, the fourth image data representing a second plurality of images corresponding to the public key, the second plurality of images received prior to receiving the second request;
determining second feature data representing second image features extracted from the third image data; and
determining, using the first feature data and the second feature data, a second probability that the third image data corresponds to an adversarial attack.

7. The computer-implemented method of claim 6, further comprising:
determining that the second probability fails to satisfy a second condition; and
in response to determining that the second probability fails to satisfy the second condition, outputting an indication of a possible adversarial attack.

8. A computer-implemented method comprising:
receiving, from a first user device, a first request for certification that first image data originated from a first camera, the first image data corresponding to a public key;
retrieving, using the public key, a first machine learning model trained to identify first features corresponding to the first camera, the first features resulting from at least one physical characteristic of the first camera;
processing the first image data using the first machine learning model to determine a first probability that the first image data originated from the first camera;
determining that the first probability satisfies a first condition;
in response to determining that the first probability satisfies the first condition, determining first certification data indicating that the first image data originated from the first camera; and
sending, to the first user device, a first indication that the first image data has been certified.

9. The computer-implemented method of claim 8, further comprising:
prior to processing the first image data using the first machine learning model:
retrieving, using the public key, first model hash data from a distributed ledger, and
retrieving, using the first model hash data, first model data corresponding to the first machine learning model from a decentralized storage system.

10. The computer-implemented method of claim 8, further comprising:
receiving, from a second user device, a second request for verification that second image data originated from the first camera, the second image data corresponding to the public key;
retrieving, using the public key, the first machine learning model;
processing the second image data using the first machine learning model to determine a second probability that the second image data originated from the first camera;
determining that the second probability satisfies a second condition;
in response to determining that the second probability satisfies the second condition, determining second certification data indicating that the second image data originated from the first camera; and
sending, to the second user device, a second indication that the second image data has been verified as originating from the first camera.

11. The computer-implemented method of claim 8, further comprising:
receiving, from a second user device, a second request for verification that second image data originated from the first camera, the second image data corresponding to the public key;
retrieving, using the public key, the first machine learning model;
processing the second image data using the first machine learning model to determine a second probability that the second image data originated from the first camera;
determining that the second probability fails to satisfy a second condition; and
in response to determining that the second probability fails to satisfy the second condition, sending, to the second user device, a second indication that the second image data could not be verified as originating from the first camera.

12. The computer-implemented method of claim 8, further comprising:
determining first image hash data corresponding to the first image data, wherein first certification data includes the first image hash data;
receiving, from a second user device, a second request to verify second image data corresponding to the public key;
determining second image hash data corresponding to the second image data;
retrieving, using the second image hash data, the first certification data from a distributed ledger, the second image hash data corresponding to the first image hash data; and
sending the first certification data to the second user device in response to the second request.

13. The computer-implemented method of claim 8, further comprising:
computing a zero-knowledge proof that the first image data was processed using the first machine learning model and that the first probability satisfies the first condition, wherein first certification includes the zero-knowledge proof.

14. A computer-implemented method comprising:
receiving, from a first user device, a first request for verification that first image data originated from a first camera, the first image data corresponding to a public key;
retrieving, using the public key, a first machine learning model trained to identify first features corresponding to the first camera, the first features resulting from at least one physical characteristic of the first camera;
processing the first image data using the first machine learning model to determine a first probability that the first image data originated from the first camera;
determining that the first probability satisfies a first condition;
in response to determining that the first probability satisfies the first condition, determining first certification data indicating that the first image data originated from the first camera; and
sending the first certification data to the first user device.

15. The computer-implemented method of claim 14, further comprising:
prior to processing the first image data using the first machine learning model:
retrieving, using the public key, first model hash data from a distributed ledger, and
retrieving, using the first model hash data, first model data corresponding to the first machine learning model from a decentralized storage system.

16. The computer-implemented method of claim 14, further comprising:
receiving, from a second user device, a second request for verification that second image data originated from the first camera, the second image data corresponding to the public key;
retrieving, using the public key, the first machine learning model;
processing the second image data using the first machine learning model to determine a second probability that the second image data originated from the first camera;
determining that the second probability fails to satisfy a second condition; and
in response to determining that the second probability fails to satisfy the second condition, sending, to the second user device, an indication that the second image data could not be verified as originating from the first camera.

17. The computer-implemented method of claim 14, further comprising:
receiving a second request for verification that second image data originated from the first camera, the second image data corresponding to the public key;
verifying, using the public key, that the second image data was digitally signed using a private key corresponding to the public key;
determining first image hash data corresponding to the second image data;
determining that the first image hash data corresponds to second certification data stored in a distributed ledger, the second certification data corresponding to second image data previously certified as originating from the first camera; and
in response to determining that the first image hash data corresponds to the second certification data, sending the second certification data in response to the second request.

18. The computer-implemented method of claim 14, further comprising:
receiving a second request for verification that second image data originated from the first camera, the second image data corresponding to the public key;
determining first feature data representing first image features extracted from third image data, the third image data representing a plurality of images corresponding to the public key, the plurality of images received prior to receiving the second request;
determining second feature data representing second image features extracted from the second image data; and
determining, using the first feature data and the second feature data, a second probability that the second image data corresponds to an adversarial attack.

19. The computer-implemented method of claim 18, further comprising:
determining that the second probability fails to satisfy a second condition; and
in response to determining that the second probability fails to satisfy the second condition, outputting an indication of a possible adversarial attack.

20. A computer-implemented method comprising:
receiving first image data representing a first plurality of images captured using a first camera;
receiving a public key corresponding to a first user device;
verifying, using the public key, that the first image data was digitally signed using a private key corresponding to the public key;
training a first machine learning model using the first image data to identify first features corresponding to the first camera, the first features resulting from at least one physical characteristic of the first camera;
determining first model hash data corresponding to the first machine learning model;
associating the first model hash data with the public key in a distributed ledger;
associating the first model hash data with first model data representing the first machine learning model; and
storing the first model data in a storage system.
